(19) United States
(12) Patent Application Publication
(10) Pub. No.: US 2026/0261291 A1
(43) Pub. Date: Sep. 3, 2026

(54) MULTI-STAGE PEAK LOCATION DETECTION METHOD FOR SATELLITE COMMUNICATIONS

(71) Applicant: YTTEK Technology Corp., Zhubei City (TW)

(72) Inventor: CHUNG-LIEN HO, Zhubei City (TW)

(21) Appl. No.: 19/390,847

(22) Filed: Nov. 17, 2025

Related U.S. Application Data
(60) Provisional application No. 63/765,464, filed on Feb. 28, 2025.

(51) Int. Cl. H04B 7/0426; H04B 7/06; H04B 17/12; H04B 17/20

(52) U.S. Cl. CPC H04B 7/043; H04B 7/06958; H04B 17/12; H04B 17/202

(57) ABSTRACT

The present invention discloses a multi-stage peak location detection method for satellite communications. The method comprises decomposing a joint/full three-dimensional (3D) search space into a plurality of lower-dimensional separate search spaces; performing peak location detection in each separate search space through a multi-stage process employing progressively decreasing step sizes; and executing angular hopping during the peak location detection to avoid effects of power dead zones, thereby achieving beam alignment with a target satellite while reducing the overall search number.

### BACKGROUND OF THE INVENTION

This application claims the priority benefit of provisional patent application No. 63/765,464 titled “MULTI-STAGE PEAK LOCATION DETECTION METHOD FOR SATELLITE COMMUNICATIONS” filed on 28 Feb. 2025, the disclosure of which is incorporated by reference herein in its entirety.

### FIELD OF INVENTION

The present invention relates to the field of satellite communications, and more particularly to a multi-stage peak location detection method for satellite communications.

### DESCRIPTION OF THE RELATED ART

Satellite communication involves the transmission of signals via electromagnetic beams between user terminals (UTs) located on the Earth's surface and target satellites in orbit. Each UT may include either fixed communication equipment or mobile communication equipment, the latter typically installed on movable platforms such as ships and vehicles. To ensure accurate link transmission, an antenna of the UT must align its beam with the target satellite.

The antenna of the UT relies on its beam directivity to focus signals toward the target satellite, thereby achieving precise link transmission. When the antenna moves relative to the target satellite, the antenna must search for the target satellite and accordingly adjust its beam alignment.

During an initial search phase of the antenna in searching for the target satellite (e.g., a cold-start phase), no prior information is available for reference.

### SUMMARY OF THE INVENTION

The main purpose of the present invention is to provide a multi-stage peak location detection method for satellite communications.

In order to achieve the aforementioned purpose, the present invention employs the following technical solution.

A multi-stage peak location detection method for satellite communications is performed in each separate search space. A peak location (PL) in a decoupled space, which serves as a first search space, is initially assigned at the start of all stages of a multi-stage peak location detection (MSPLD) process. The pre-assigned peak location (PL) is iteratively refined by applying a random-sign decreasing displacement distance, namely an angular displacement, in the decoupled space. All stages in each search space are executed sequentially, with each stage adopting a different peak location detection (PLD) step sizes. Each stage also requires a predetermined estimate obtained from other search spaces for the current target space during the multi-stage peak location detection (MSPLD) process. Prior to detection, a set of search candidates is provided for each stage of the predetermined space. For each stage, a peak location (PL) and a corresponding beamforming (BF) output power are calculated, and the final search space may optionally employ curve fitting techniques to enhance detection precision.

The primary effects and advantages of the present invention are as follows. By decomposing a joint/full three-dimensional (3D) search space into a plurality of lower-dimensional separate search spaces, and by employing a multi-stage peak location detection strategy with progressively decreasing step sizes in combination with an angular hopping procedure, the overall number of searches is effectively reduced, computational complexity is decreased, and decision time is shortened. As a result, the anti-noise capability and overall communication performance are significantly improved.

### BRIEF DESCRIPTION OF THE DRAWINGS

FIG. 1 shows a schematic diagram illustrating an estimate of a mechanical antenna orientation in a three-dimensional (3D) search space.

FIG. 2 shows a definition of an antenna orientation in a three-dimensional (3D) space.

FIG. 3 shows a search candidate set in a specific search space.

FIG. 4 shows a spatial decoupling mechanism of the present invention.

FIG. 5 shows a multi-stage peak location detection (MSPLD) mechanism of the present invention.

FIG. 6 shows a beamforming (BF) output power profile along a slant (γ) axis.

FIG. 7 shows an angular hopping process of the present invention.

FIG. 8 shows a detection process of multi-stage peak location detection (MSPLD).

FIG. 9 shows a beamforming (BF) output power profile along a specific antenna orientation axis.

FIG. 10 shows an input/output relationship of peak location detection (PLD) in a specific detection stage of a specific search space.

FIG. 11 shows an algorithm for performing peak location detection (PLD) in a specific detection stage of a specific search space.

FIG. 12 shows a three-dimensional (3D) beamforming (BF) output power profile with a resolution of 1° along a bearing (a) axis and a down-tilt (β) axis.

FIG. 13 shows a three-dimensional (3D) beamforming (BF) output power profile with a resolution of 3° along the bearing (a) axis and the down-tilt (β) axis.

FIG. 14 shows a three-dimensional (3D) beamforming (BF) output power profile with a resolution of 100 along the bearing (a) axis and the down-tilt (β) axis.

FIG. 15 shows a beamforming output (BF) power profile along the slant (γ) axis.

FIG. 16 shows a peak location detection (PLD) module for a specific search space.

FIG. 17 shows a peak location detection (PLD) module in a specific detection stage for a specific search space, the module having an input/output interface.

FIG. 18 shows an overall detection process of multi-stage peak location detection (MSPLD), the process having an input/output interface.

FIG. 19 shows a multi-stage peak location detection (MSPLD) module having an input/output interface.

FIG. 20 shows an algorithm of multi-stage peak location detection (MSPLD) for all search spaces.

FIG. 21 shows a flowchart of multi-stage peak location detection (MSPLD) for all search spaces.

FIG. 22 shows a schematic diagram of array index mapping.

### DETAILED DESCRIPTION OF THE PREFERRED EMBODIMENTS

The accompanying drawings illustrate embodiments of a multi-stage peak location detection method for satellite communications according to the present invention. These embodiments are provided solely for illustrative purposes and are not intended to limit the scope of the invention.

An optimal search method for a three-dimensional joint space employing a full-angle or global search is a three-dimensional main beam acquisition method, which constitutes a brute-force (exhaustive) blind search (scanning) mechanism. This method may probe the three axes of an antenna one at a time or alternate probe between the three axes. The method is simple and low-cost but time-consuming, and its performance thereof depends on a step size or a signal-to-noise ratio (SNR). Moreover, it does not require any prior information. A two-stage strategy for a uniform exhaustive search includes using a larger fixed step size for large-scale probing in a first stage, followed by small-scale probing in a second stage using a smaller fixed step size around the search points obtained from the first stage. When a pointing error is within a 3 dB beamwidth, a search-stop condition is satisfied, thereby achieving a minimum link level required for beam alignment (for control signaling). For example: Pᵣₓ≥Pₘᵢₙ≈P_{3dB}.

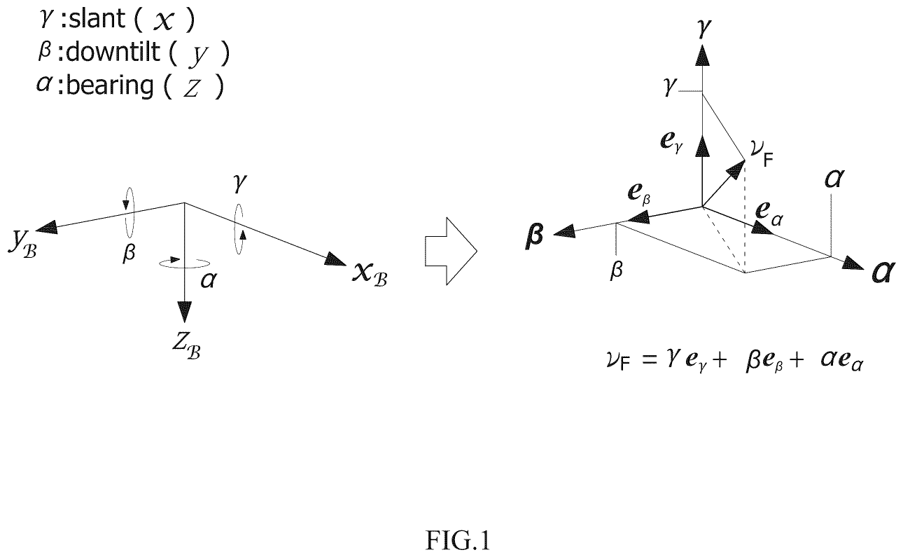

As shown in FIG. 1, an issue with the brute-force mechanism (i.e., an exhaustive linear or uniform search) is that for exhaustive peak location detection (PLD) of a receive (Rx) beamforming (BF) output, an objective function is the receive (Rx) beamforming (BF) output power. The power is a function of an antenna direction, i.e., the power is controlled by three directions (γ, β, α), and can be expressed as a three-variable function g=f_{γβα}(γ, β, α)≡g_{γβα}. The objective is to find an antenna direction (γ, β, α) that maximizes the receive (Rx) beamforming (BF) output power g. A peak location (PL) in the three-dimensional (3D) joint space, which is spanned by three-dimensional orthonormal standard bases (e_{γ}, e_{β}, e_{α}), can be estimated through the corresponding direction (γ, β, α) by measuring a joint objective function g_{F} over the entire three-dimensional space, wherein the peak location (PL) is represented as g_{F}=g_{γβα}=f_{γβα}(γ, β, α).

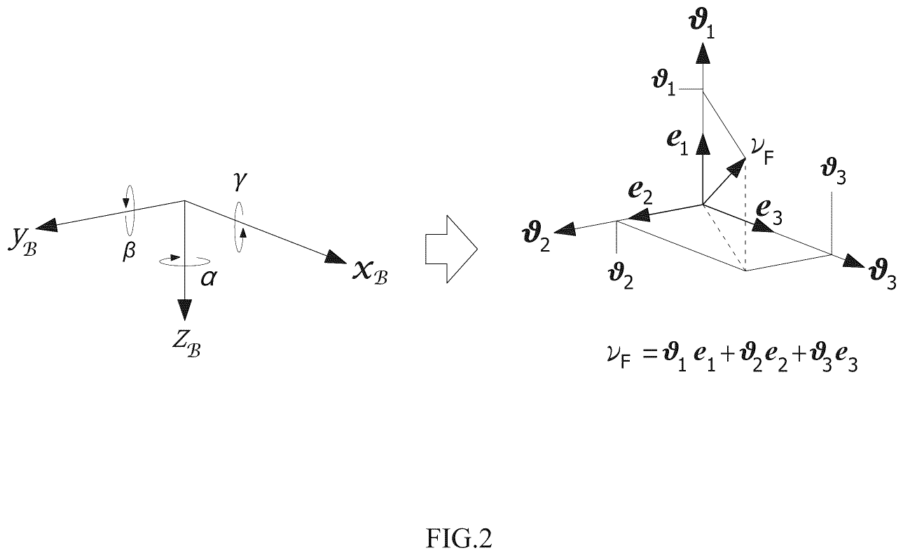

As shown in FIG. 2, uniform peak location detection (PLD) is performed on a candidate set V_{F} in a joint/full three-dimensional (3D) search space [symbol] _{F} for all possible search candidate points. The term ‘uniform’ refers to the uniform distribution of search candidate points, the distribution being defined by a specified starting position and step size. The joint/full three-dimensional (3D) search space [symbol] _{F} is mathematically expressed as follows:

$${𝒮}_{F} ≡ Span \{ {e}_{1} . {e}_{2} , {e}_{3} \} = \{ {ϑ}_{1} {e}_{1} + {ϑ}_{2} {e}_{2} + {ϑ}_{3} {e}_{3} \vert {ϑ}_{i} ∈ ℝ \} ∈ {ℝ}^{3} ,$$

$$where :$$

$${e}_{1} ≡ {[ 1 , 0 , 0 ]}^{T} , {e}_{2} ≡ {[ 0 , 1 , 0 ]}^{T} , {e}_{2} ≡ {[ 0 , 0 , 1 ]}^{T} ,$$

[symbol] _{F} represents the joint/full (3D, D_{F}=3) search space,
eᵢ∈ [symbol] ³ denotes an i^{th} orthonormal basis specifying the i^{th} search direction ϑᵢ in [symbol] _{F}, and
ϑᵢ represents a coefficient of the i^{th} standard basis specifying the i^{th} search position.

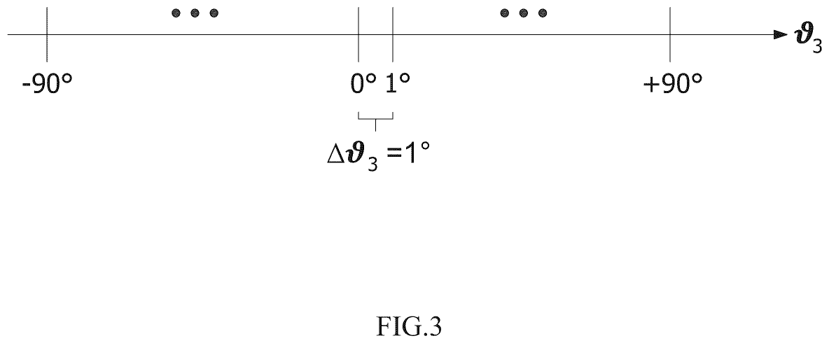

As shown in FIG. 3, a uniform (linear) search is defined as follows:

$${V}_{F} ≡ \{ \tilde{ϑ} \} ∈ {ℝ}^{3} ,$$

where V_{F} represents the uniform search set containing total N_{F} possible candidates {\tilde{ϑ}}ₗ, l=1, . . . , N_{F}.

Each candidate is expressed as:

$${\{ \tilde{ϑ} \}}_{l} ≡ {[ {\{ {\tilde{ϑ}}_{1} \}}_{{l}_{1}} , {\{ {\tilde{ϑ}}_{2} \}}_{{l}_{2}} , {\{ {\tilde{ϑ}}_{3} \}}_{{l}_{3}} ]}^{T} ∈ {ℝ}^{3} ,$$

where l=map((j₁, j₂, j₃))=1, . . . , N_{F}.

For the i^{th} search direction ϑᵢ:

$${V}_{i} ≡ \{ {\tilde{ϑ}}_{i} \} ∈ {ℝ}^{1} ,$$

where Vᵢ is the uniform search set containing Nᵢ candidates {\tilde{ϑ}ᵢ}lᵢ∈ [symbol] ¹, lᵢ=1, . . . , Nᵢ, along the i^{th} search direction ϑᵢ.

### Search Parameters:

Search range: Along the i^{th} search direction ϑᵢ, the range is determined by FoV Θᵢ:

$${Θ}_{i , m i n} \leq {\tilde{ϑ}}_{i} , {\tilde{ϑ}}_{i} \leq {Θ}_{i , ma x} , {Θ}_{i} ≡ {Θ}_{i , m ax} - {Θ}_{i , m i n} .$$

Step size: The constant step size (i.e., search spacing) along the i^{th} search direction ϑᵢ is denoted as Δϑᵢ.

Number of candidates: The number of candidates (i.e., size of search set) Nᵢ along the i^{th} search direction ϑᵢ is given by:

$${N}_{i} ≡ L ( {V}_{i} ) = L ( \{ {\tilde{ϑ}}_{i} \} ) = ⌈ \frac{{Θ}_{i}}{{Δϑ}_{i}} ⌉ .$$

Specifically, FIG. 3 shows a search candidate set V₃ along a third search direction ϑ₃, wherein the search range is Θ₃=180°, the step size is Δϑ₃=1°, and thus the number of candidate points is N₃ [Θ₃/ϑ₃]=180. The search range therefore extends from −90° to +90°.

A total number of candidate points N_{C} (i.e., the total searches) in the joint/full three-dimensional (3D) search space [symbol] _{F} is defined as follows:

$${N}_{C} ≡ L ( {V}_{F} ) = L ( \{ \tilde{ϑ} \} ) = {\prod }_{i = 1}^{{D}_{F} = 3} {N}_{i} = {N}_{1} {N}_{2} {N}_{3} ,$$

For example, if {\tilde{ϑ}}∈ [symbol] ², and N₁=2, N₂=3, i=1,2, then N_{F}=N₁N₂=6. The candidate set {\tilde{ϑ}} is as shown below:

$$\{ \tilde{ϑ} \} = \{ {\underbrace{[ \begin{matrix}{\{ {ϑ}_{1} \}}_{1} \\ {\{ {ϑ}_{2} \}}_{1}\end{matrix} ]}}_{l = 1 : {\{ \tilde{ϑ} \}}_{1}} , {\underbrace{[ \begin{matrix}{\{ {ϑ}_{1} \}}_{1} \\ {\{ {ϑ}_{2} \}}_{2}\end{matrix} ]}}_{l = 2 : {\{ \tilde{ϑ} \}}_{2}} , {\underbrace{[ \begin{matrix}{\{ {ϑ}_{1} \}}_{1} \\ {\{ {ϑ}_{2} \}}_{3}\end{matrix} ]}}_{l = 3 : {\{ \tilde{ϑ} \}}_{3}} , {\underbrace{[ \begin{matrix}{\{ {ϑ}_{1} \}}_{2} \\ {\{ {ϑ}_{2} \}}_{1}\end{matrix} ]}}_{l = 4 : {\{ \tilde{ϑ} \}}_{4}} , {\underbrace{[ \begin{matrix}{\{ {ϑ}_{1} \}}_{2} \\ {\{ {ϑ}_{2} \}}_{2}\end{matrix} ]}}_{l = 5 : {\{ \tilde{ϑ} \}}_{5}} , {\underbrace{[ \begin{matrix}{\{ {ϑ}_{1} \}}_{2} \\ {\{ {ϑ}_{2} \}}_{3}\end{matrix} ]}}_{l = 6 : {\{ \tilde{ϑ} \}}_{6}} \}$$

In the joint/full three-dimensional (3D) search space [symbol] _{F}, a total search number, i.e., a total number of candidate points N_{C}, is calculated as follow:

$${N}_{C} = {N}_{1} {N}_{2} {N}_{3}$$

Example 1: Θ₁=180°, Θ₂=90°, ι₃=360°, and Δϑ₁=Δϑ₂=Δϑ₃=1°: thus N_{C}=180×90×360=5,832×10³.

Example 2: Θ₁=180°, Θ₂=90°, Θ₃=360°, and Δϑ₁=Δϑ₂=Δϑ₃=3° (3 dB beamwidth in bearing/down-tilt is approximately BW_{3dB}=3.16° for a 32-element array); thus N_{C}=60×30×120=216×10³.

However, in a mechanical antenna orientation mechanism, although a direct brute-force solution is straightforward and capable of achieving optimal results, the large number of searches required results in significant computational time and causes mechanical structural wear.

A suboptimal solution is therefore recommended, in which a spatial decoupling technique is used to reduce the dimensionality of the search space. In general, K=2 separate search spaces can be constructed to reduce the total number of searches. A multi-stage peak location detection (MSPLD) method is then proposed, in which the search step size successively decreases across stages. In general, Q=2 stages are sufficient to further reduce computational complexity and accelerate decision time. In addition, an angular hopping process (usually with P=2 hopping processes) can be incorporated to avoid power dead zones during peak location detection (PLD), thereby improving overall system performance. Here, K represents the number of lower-dimensional search space formed by decoupling, Q represents the number of stages in the multi-stage peak location detection, and P represents the number of hopping processes in the angular hopping.

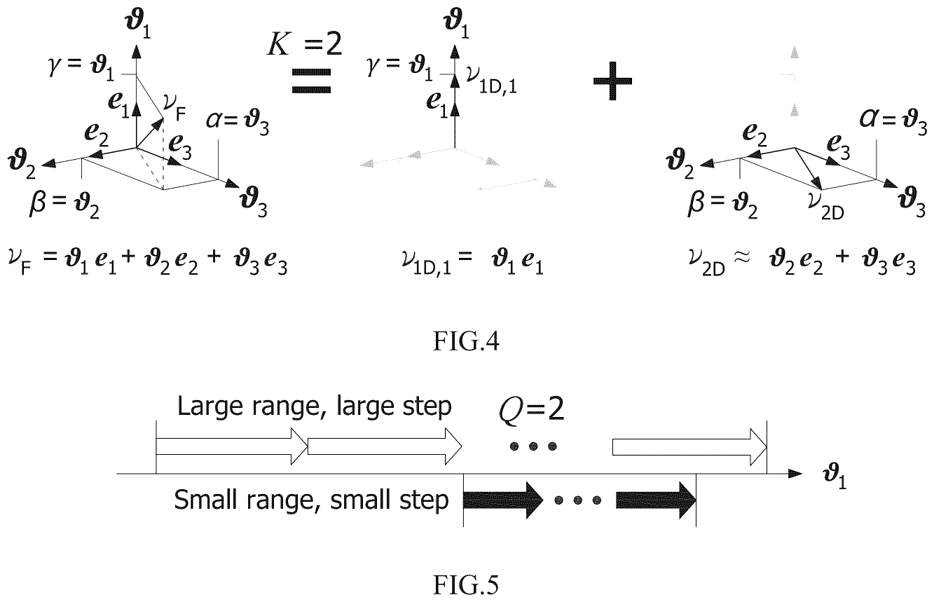

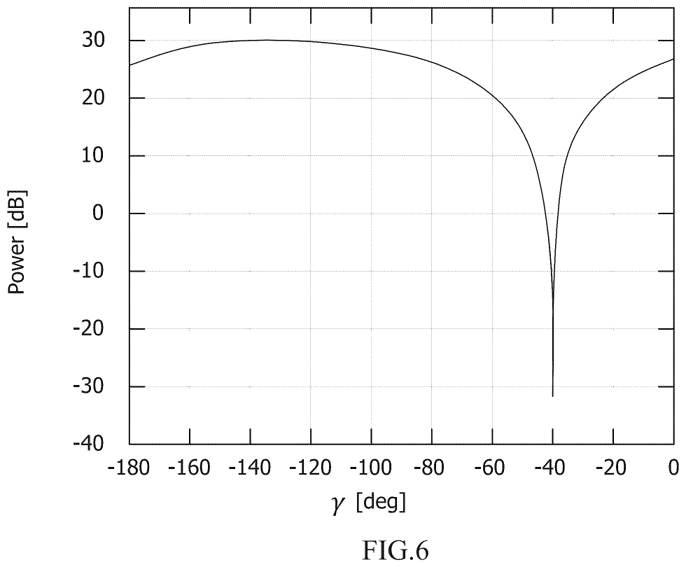

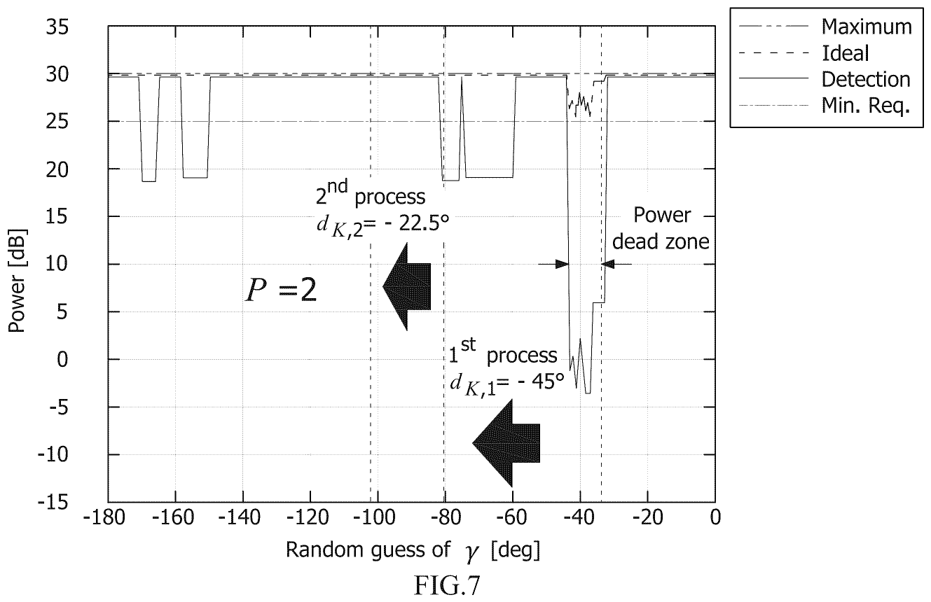

As shown in FIGS. 4 through 7, for an initial target satellite search during a cold-start phase, a suboptimal solution is proposed that includes the following main operations: (1) performing spatial decoupling to reduce the dimensionality of the search space; (2) performing multi-stage peak location detection (MSPLD) for shortening processing time; and (3) executing angular hopping to avoid power dead zones during peak location detection (PLD).

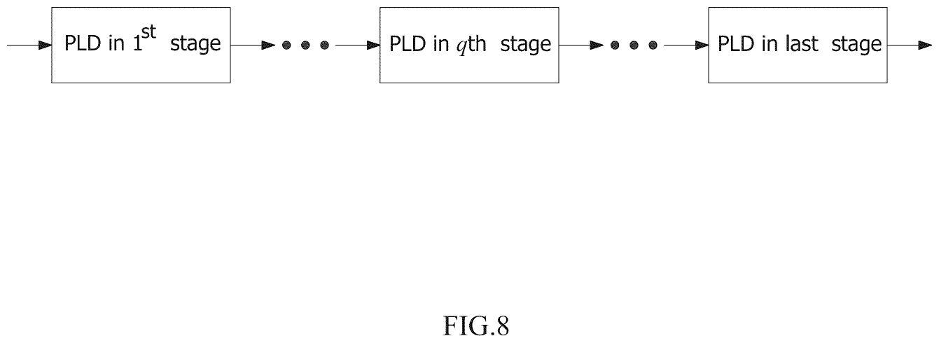

As shown in FIG. 8, multi-stage peak location detection (MSPLD) is performed in each separate search space. Specifically, sequential or iterative (i.e., multi-stage) peak location detection is performed in each separate search space. For a k^{th} space [symbol] _{D,k}, peak location detection is sequentially executed across Qₖ stages. In generally, Qₖ=2 is sufficient for all separate search spaces to achieve compatible performance in most application examples. For simplicity of explanation, it is assumed that the number of stages for all the separate search spaces is Qₖ=Q=2.

In a q^{th} stage, a starting point ϑ_{k,q,i}_{ₖ}(1), a scanning range Θ_{k,q,i}_{ₖ}, and a step-size Δϑ_{k,q,i}_{ₖ} are preset along an iₖ^{th} search direction in a k^{th} search space. These parameters should satisfy the following conditions:
Condition 1: As the stage index increases, both the scanning range (i.e., FoV) Θ_{k,q,i}_{ₖ} and the step-size Δϑ_{k,q,i}_{ₖ} successively decrease.
Condition 2: The scanning range of a current stage is twice the step size of the previous stage, i.e., Θ_{k,q,i}_{ₖ}=2Δϑ_{k,q-1,i}_{ₖ}.
Condition 3: The step size Δϑ_{k,q,i}_{ₖ} should be smaller than a 3 dB beamwidth (BW_{3dB}) of the search direction to avoid local minima and local maxima.
Condition 4: The displacement amount of the starting point should be smaller than the step size, i.e., l_{k,q,i}_{ₖ}(1)≤Δϑ_{k,q,i}_{ₖ}.

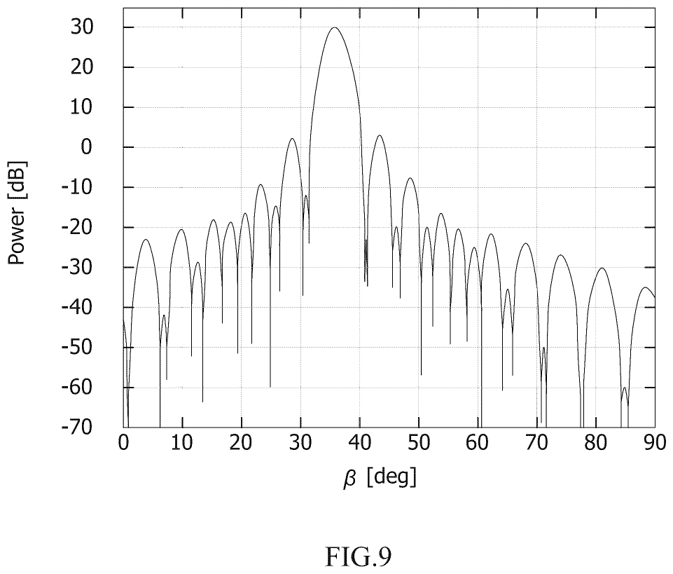

As shown in FIG. 9, the search step size at each search stage must be carefully designed. Traditional methods, such as the bisection method, are not suitable for application scenarios involving peak location detection (PLD) of beamforming output amplitude or power, because the beamforming output amplitude or power is not a monotonic function. This limitation arises from the fact that the bisection method halves the search range at each step, which, under a non-monotonic function, inevitably leads the peak location detection (PLD) to fall into local extrema (maxima or minima).

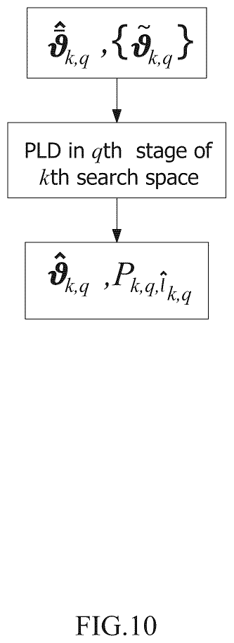

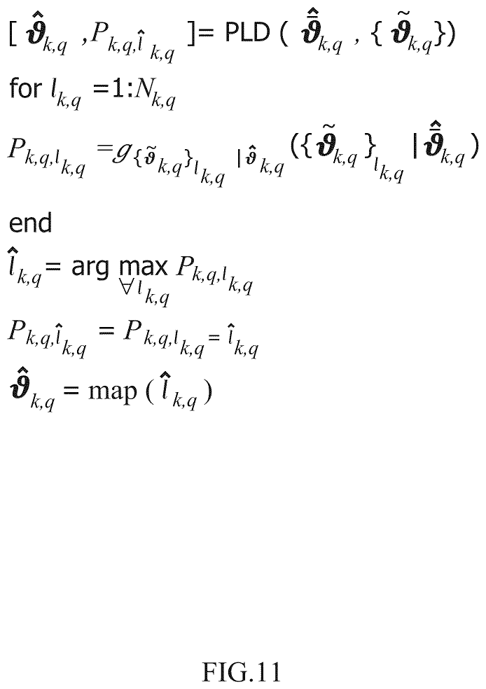

As shown in FIG. 10, an algorithm summary of peak location detection (PLD) for a q^{th} stage of a k^{th} search space is described as follows: In an input portion, [symbol] _{k,q} represents an estimate of a peak location at the q^{th} stage derived from search spaces other than the k^{th} search space, and {\tilde{ϑ}_{k,q}} represents a candidate set at the q^{th} stage of the k^{th} search space. In an output portion, \hat{ϑ}_{k,q} represents an estimate of a peak location at the q^{th} stage of the k^{th} search space, and P_{k,q,\hat{l},}_{_{k,q}} represents a peak output power at the q^{th} stage of the k^{th} search space. As shown in FIG. 11, specific steps of the peak location detection algorithm include the following: (1) substituting the input peak location estimate and candidate set; (2) for candidate indices l_{k,q}=1 to N_{k,q} sequentially calculating the output power P_{k,q,\hat{l},}_{_{k,q}}; (3) selecting an index \hat{l}_{k,q} corresponding to the maximum output power value, and using the corresponding output power as the peak output power P_{k,q,\hat{l},}_{_{k,q}}; and (4) obtaining a peak location estimate \hat{ϑ}_{k,q} through index mapping map \hat{l}_{k,q}.

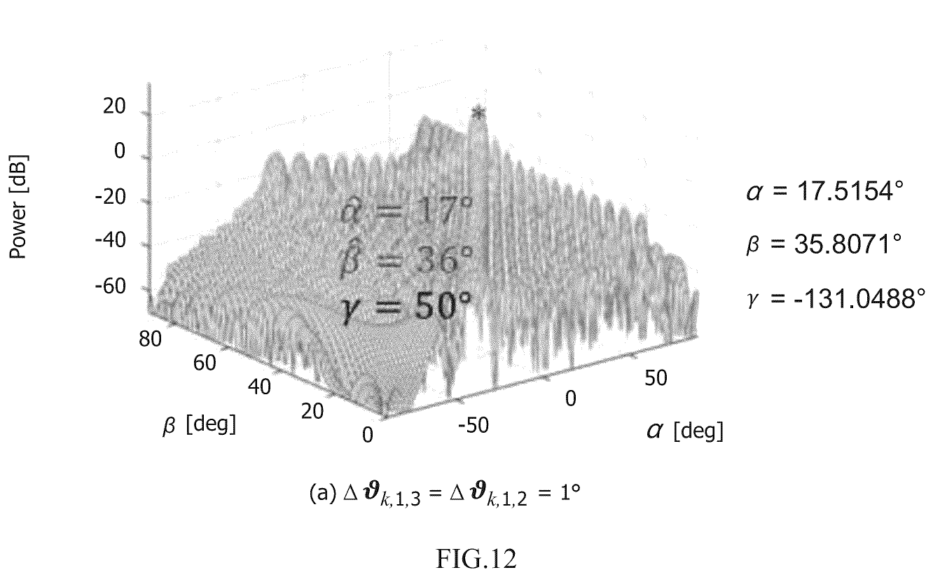

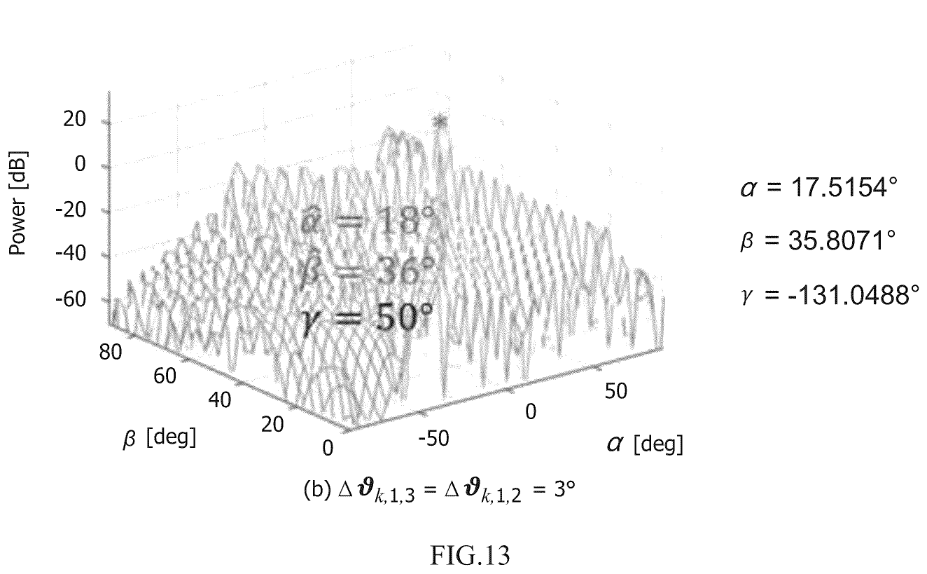

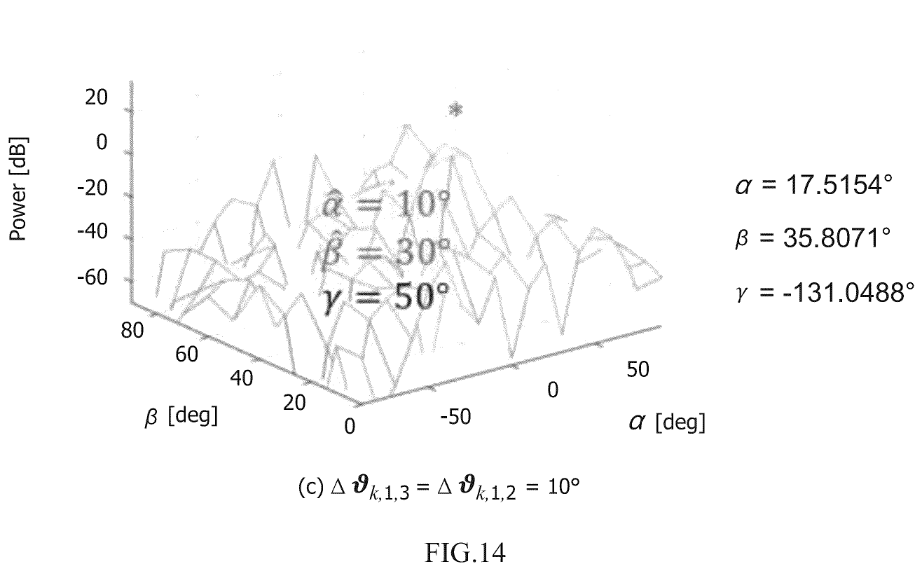

As shown in FIGS. 12, 13, and 14. Example 3 demonstrates a two-stage peak location detection (PLD) process applied to two separate search spaces: a first (retrograde) search space [symbol] _{D,1}, spanned by e₂ and e₃, and a second (decoupled) search space [symbol] _{D,2}, spanned by e₁. In the first stage, large-scale global (full-angle) searches are performed in both the first search space [symbol] _{D,1} and the second search space [symbol] _{D,2}, e.g., Θ_{k,1,1}=180°, Θ_{k,1,2}=90°, Θ_{k,1,3}=360°, and a larger fixed step size Δϑ_{k,1,i}_{ₖ} is used, e.g., Δϑ_{k,1,1}=Δϑ_{k,1,2}=Δϑ_{k,1,3}=10°. In the second stage, small-scale local (partial-angle) searches are performed in both the first search space [symbol] _{D,1} and the second search space [symbol] _{D,2}, with search ranges such as Θ_{k,2,i}_{ₖ}, e.g., Θ_{k,2,1}=2Δϑ_{k,1,1}, Θ_{k,2,2}=2Δϑ_{k,1,2}, Θ_{k,2,3}=2Δϑ_{k,1,3}, where the search range Θ_{k,2,i}_{ₖ}=2Δϑ_{k,1,i}_{ₖ} is twice the step size of the previous stage. A smaller fixed step size Δϑ_{k,2,i}_{ₖ} is used, e.g., Δϑ_{k,2,1}=Δϑ_{k,2,2}=Δϑ_{k,2,3}=3°.

A total search number of the multi-stage peak location detection (MSPLD) is calculated as follows:

$${N}_{C} = {\sum }_{k = 1}^{K} {N}_{D , k} = {\sum }_{k = 1}^{K} {\underbrace{{\sum }_{q = 1}^{{Q}_{k}} {N}_{D , k , q}}}_{{N}_{D , k}} = {\sum }_{k = 1}^{K} {\sum }_{q = 1}^{{Q}_{k}} {\underbrace{{\prod }_{{i}_{k}}^{{D}_{k}} {N}_{k , q , {i}_{k}}}}_{{N}_{D , k , q}}$$

where N_{D,k} represents a search number of a k^{th} separate space [symbol] _{D,k}; N_{D,k,q} represents a search number in a q^{th} stage of the k^{th} separate space [symbol] _{D,k}; and N_{k,q,i}_{ₖ} represents a number of searches along an iₖ^{th} search direction in the q^{th} stage of the k^{th} separate space [symbol] _{D,k}, the number corresponding to a scanning region Θ_{k,q,i}_{ₖ} and step size Δϑ_{k,q,i}_{ₖ}.

Example 4: If the joint/full three-dimensional (3D) search space [symbol] _{F} is decomposed into one separate first search space [symbol] _{D,1} and one separate second search space [symbol] _{D,2}, wherein the first search space [symbol] _{D,1} is a two-dimensional joint search space spanned by e₂ and e₃, and the second search space [symbol] _{D,2} is a one-dimensional search space spanned by e₁, then under two-stage peak location detection (PLD), a total search number is calculated as follows:
For the first search space [symbol] _{D,1} (k=1):

$${N}_{D , 1} = {N}_{D , 1 , 1} + {N}_{D , 1 , 2} = ( {N}_{1 , 1 , 1} {N}_{1 , 1 , 2} ) + ( {N}_{1 , 2 , 1} {N}_{1 , 2 , 2} ) .$$

For the second search space [symbol] _{D,2} (k=2):

$${N}_{D , 2} = {N}_{D , 2 , 1} + {N}_{D , 2 , 2} = ( {N}_{2 , 1 , 1} ) + ( {N}_{2 , 2 , 1} ) .$$

Example 5: Using a direct exhaustive search and two-stage detection, a total search number of the joint/full three-dimensional (3D) search space [symbol] _{F} is calculated as follows:

$${N}_{C} = {\sum }_{q = 1}^{Q} {N}_{F , q} = {\sum }_{q = 1}^{Q} {\underbrace{{\prod }_{k = 1}^{K = 3} {N}_{k , q}}}_{{N}_{F , q}}$$

where N_{F,q} represents a “full search number” in a q^{th} stage, i.e., a product of candidate numbers in each search direction in a three-dimensional space; N_{k,q} represents a candidate number along a k^{th} search direction in a q^{th} stage.

The results for the joint/full three-dimensional (3D) search space [symbol] _{F} are as follows:

$$First Stage : e . g . , {Θ}_{1 , 1} = 180 ° , {Θ}_{2 , 1} = 90 ° , {Θ}_{3 , 1} = 360 ° , {Δϑ}_{1 , 1} = {Δϑ}_{2 , 1} = {Δϑ}_{3 , 1} = 6 ° : {N}_{F , 1} = 31 \times 16 \times 61 = 30 , 256.$$

$$Second Stage : e . g . , {Θ}_{1 , 2} = 2 {Δϑ}_{1 , 1} = 12 ° , {Θ}_{2 , 2} = 2 {Δϑ}_{2 , 1} = 12 ° , {Θ}_{3 , 2} = 2 {Δϑ}_{3 , 1} = 12 ° , {Δϑ}_{1 , 2} = {Δϑ}_{2 , 2} = {Δϑ}_{3 , 2} = 3 ° : {N}_{F , 2} = 5 \times 5 \times 5 = 125 .$$

A total search number is thus calculated as: N_{C}=N_{F,1}+N_{F,2}=30,381.

Example 6: If the joint/full three-dimensional (3D) search space [symbol] _{F} is decomposed into two separate search spaces (i.e., K=2), including a first search space [symbol] _{D,1} (k=1) and a second search space [symbol] _{D,2}(k=2), wherein the second search space [symbol] _{D,2} is a first separate search space obtained by decoupling the joint/full three-dimensional (3D) search space [symbol] _{F}, then under two-stage peak location detection, a total search number is calculated as follows:
1. For the first search space [symbol] _{D,1} (k=1): N_{D,1}=N_{D,1,1}+N_{D,1,2}=(N_{1,1,1}N_{1,1,2})+(N_{1,2,1}N_{1,2,2}):

$$First Stage : {Θ}_{1 , 1 , 1} = 360 ° , {Θ}_{1 , 1 , 2} = 90 ° , {Δϑ}_{1 , 1 , 1} = {Δϑ}_{1 , 1 , 2} = 10 ° , {N}_{1 , 1 , 1} {N}_{1 , 1 , 2} = 370 , where , {Δϑ}_{1 , 1 , 1} = {Δϑ}_{1 , 1 , 2} = 10 ° .$$

$$Second Stage : {Θ}_{1 , 2 , 1} = 2 {Δϑ}_{1 , 1 , 1} = 20 ° , {Θ}_{1 , 2 , 2} = 2 {Δϑ}_{1 , 1 , 2} = 20 ° , {Δϑ}_{1 , 2 , 1} = {Δϑ}_{1 , 2 , 2} = 3 ° , {N}_{1 , 2 , 1} {N}_{1 , 2 , 2} = 7 \times 7 = 49 .$$

2. For the second search space [symbol] D,2 (k=2): N_{D,2}=N_{D,2,1}+N_{D,2,2}=(N_{2,1,1})+(N_{2,2,1}):

$$First Stage : {Θ}_{2 , 1 , 1} = 180 ° , {Δϑ}_{2 , 1 , 1} = 10 ° , {N}_{2 , 1 , 1} = 19.$$

$$Second Stage : {Θ}_{2 , 2 , 1} = 2 {Δϑ}_{2 , 1 , 1} = 20 ° , {Δϑ}_{2 , 2 , 1} = 3 ° , {N}_{2 , 2 , 1} = 7 .$$

A total search number is calculated as: N_{C}=(N_{1,1,1}N_{1,1,2})+(N_{1,2,1}N_{1,2,2})+(N_{2,1,1})+(N_{2,2,1})=445.

Example 7: If the joint/full (3D) search space [symbol] _{F} is decomposed into two separate search spaces (i.e., K=2), including a first search space [symbol] _{D,1} (k=1) and a second search space [symbol] _{D,2}(k=2), a total search number can be determined using two-stage peak location detection (PLD) as follows:
1. For the first search space [symbol] _{D,1} (k=1): N_{D,1}=N_{D,1,1}+N_{D,1,2}=(N_{1,1,1}N_{1,1,2})+(N_{1,2,1}N_{1,2,2}):

$$First Stage : {Θ}_{1 , 1 , 1} = 360 ° , {Θ}_{1 , 1 , 2} = 90 ° , {Δϑ}_{1 , 1 , 1} = {Δϑ}_{1 , 1 , 2} = 6 ° , {N}_{1 , 1 , 1} {N}_{1 , 1 , 2} = 976.$$

$$Second Stage : {Θ}_{1 , 2 , 1} = 2 {Δϑ}_{1 , 1 , 1} = 12 ° , {Θ}_{1 , 2 , 2} = 2 {Δϑ}_{1 , 1 , 2} = 12 ° , {Δϑ}_{1 , 2 , 1} = {Δϑ}_{1 , 2 , 2} = 3 ° , {N}_{1 , 2 , 1} {N}_{1 , 2 , 2} = 25 .$$

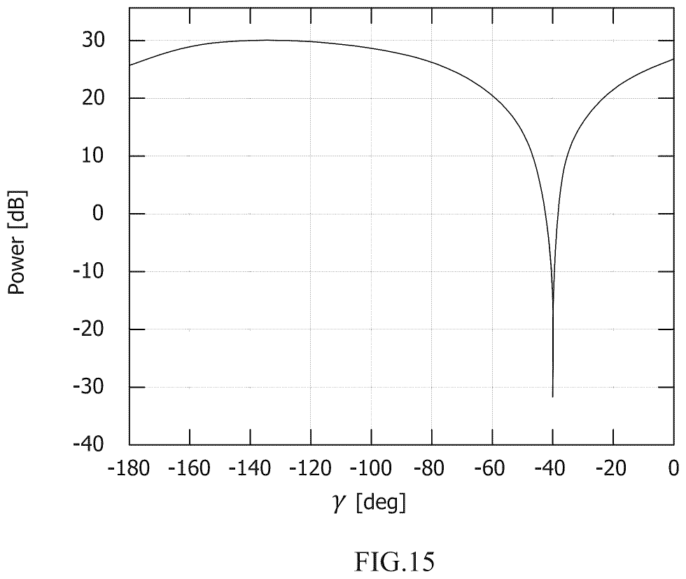

2. For second search space [symbol] _{D,2}, [symbol] _{D,2} (k=2): N_{D,2}=N_{D,2,1}+N_{D,2,2}=(N_{2,1,1})+(N_{2,2,1}) (as shown in FIG. 15):

$$First Stage : {Θ}_{2 , 1 , 1} = 180 ° , {Δϑ}_{2 , 1 , 1} = 6 ° , {N}_{2 , 1 , 1} = 31.$$

$$Second Stage : {Θ}_{2 , 2 , 1} = 2 {Δϑ}_{2 , 1 , 1} = 12 ° , {Δϑ}_{2 , 2 , 1} = 3 ° , {N}_{2 , 2 , 1} = 5 .$$

A total search number is calculated as: N_{C}=(N_{1,1,1}N_{1,1,2})+(N_{1,2,1}N_{1,2,2})+(N_{2,1,1})+(N_{2,2,1})=1,037.

Referring to Examples 5 and 7, a ratio R defined as

$$R = \frac{{N}_{C , SD \_ TS}}{{N}_{C , F \_ TS}} = \frac{1 , 037}{30 , 381} \approx 3.4 \%$$

can be obtained, where a numerator N_{C,SD_TS} represents a total search number using spatial decoupling and two-stage peak location detection (as in Example 7), and a denominator N_{C,F_TS} represents a total search number using joint/full three-dimensional (3D) two-stage search (as in Example 5). It should be noted that, when comparing Example 6 and Example 7, Example 7 employs a smaller step size of Δϑ_{2,1,1}=6°, resulting in slightly improved performance due to the relatively flat main beam characteristics of the search space in the y direction (as shown in FIG. 15), albeit with increased computational complexity. The ratio R is defined specifically based on the comparison between Example 7 and Example 5, rather than between Example 6 and Example 7.

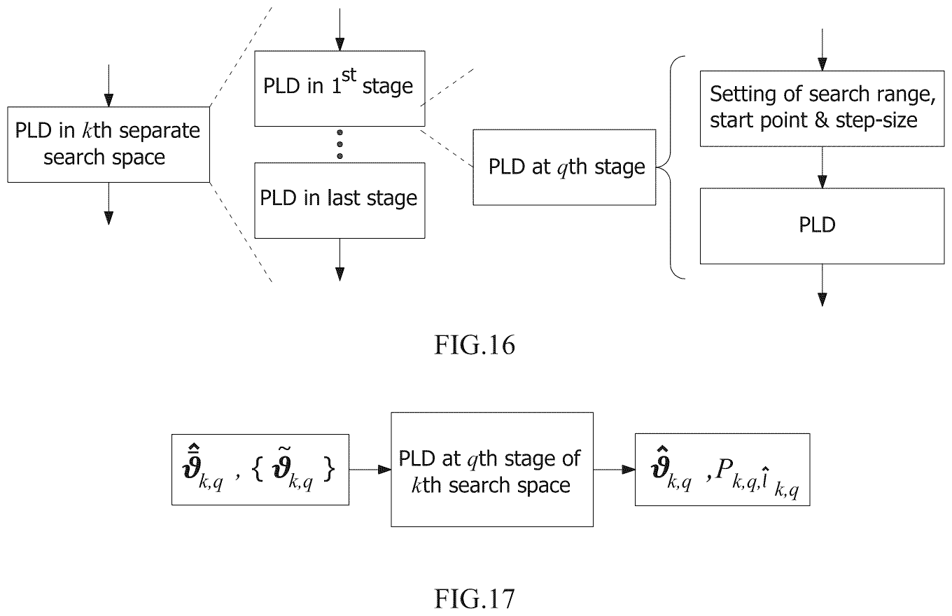

As shown in FIG. 16, a peak location detection module for a k^{th} separate search space [symbol] _{F} must be capable of providing a predetermined estimate value derived from other search spaces in the multi-stage peak location detection process, the estimate value being applicable to the current target space. The estimate value can be a “random guess” or a “reasonable estimate.” Herein, the peak location detection module refers to a subroutine executed for a specific search space within the multi-stage peak location detection method. For each stage, the peak location detection module must include parameters comprising: a scanning range Θ_{k,q,i}_{ₖ}, a displacement amount l_{k,q,i}_{ₖ} (1) of a first starting point, and a fixed step size Δϑ_{k,q,i}_{ₖ}. Predetermined estimate values must be provided before performing detection in each stage of a search space [symbol] _{D,K}. In addition, in a final search space, curve fitting techniques may be applied to further enhance detection accuracy.

In a q^{th} stage of a k^{th} separate search space [symbol] _{D,k} ␣ [symbol] ^{D}^{ₖ}, along an iₖ^{th} search direction, a search candidate set V_{k,q,i}_{ₖ}∈ [symbol] ¹ is defined with the following parameters:
[symbol] _{k,q,i}_{ₖ}: represents an estimated center of a region of interest (ROI) in a q^{th} stage of search spaces other than the k^{th} search space;
Θ_{k,q,i}_{ₖ}: represents a field-of-view (FoV);
Δϑ_{k,q,i}_{ₖ}: represents a step size;
l_{k,q,i}_{ₖ}(1): represents a displacement amount of a first starting point, satisfying l_{k,q,i}_{ₖ}(1)≤Δϑ_{k,q,i}_{ₖ} and
N_{k,q,i}_{ₖ}: represents a number of candidate points.

The search candidate set is defined as follows:

$${V}_{k , q , {i}_{k}}^{′} = \{ {\tilde{ϑ}}_{k , q , {i}_{k}}^{′} \} = \{ ( {\hat{\overline{ϑ}}}_{k , q , {i}_{k}} - \frac{{Θ}_{k , q , {i}_{k}}}{2} ) \} : {Δϑ}_{k , q , {i}_{k}} : ( {\hat{\overline{ϑ}}}_{k , q , {i}_{k}} + \frac{{Θ}_{k , q , {i}_{k}}}{2} ) \} ;$$

where an initial number of candidate points is:

$${N}_{k , q , {i}_{k}}^{′} = L ( \{ {\tilde{ϑ}}_{k , q , {i}_{k}}^{′} \} ) = \frac{{Θ}_{k , q , {i}_{k}}}{{Δϑ}_{k , q , {i}_{k}}} + 1 ;$$

and an actual candidate set is:

$${V}_{k , q , {i}_{k}} = \{ {\tilde{ϑ}}_{k , q , {i}_{k}} \} = \{ ( {\{ {\tilde{ϑ}}_{k , q , {i}_{k}}^{′} \}}_{1} + {l}_{k , q , {i}_{k}} ( 1 ) - 1 ) : {Δϑ}_{k , q , {i}_{k}} : {\{ {\tilde{ϑ}}_{k , q , {i}_{k}}^{′} \}}_{{N}_{k , q , {i}_{k}}^{′}} \} ;$$

and an actual number of candidate points is

$${N}_{k , q , {i}_{k}} = L ( \{ {\tilde{ϑ}}_{k , q , {i}_{k}} \} ) .$$

In a q^{th} stage of a k^{th} search space [symbol] _{D,k}∈ [symbol] ^{D}^{ₖ}, the search candidate set V_{k,q}∈ [symbol] ^{D}^{ₖ} is defined as:

$${V}_{k , q} = \{ {\tilde{ϑ}}_{k , q} \} ∈ {ℝ}^{{D}_{k}} ;$$

where each candidate point is expressed as:

$${\{ {\tilde{ϑ}}_{k , q} \}}_{{l}_{k , q}} = {[ {\{ {\tilde{ϑ}}_{k , q , 1} \}}_{{l}_{k , q , 1}} , ⋯ , {\{ {\tilde{ϑ}}_{k , q , {D}_{k}} \}}_{{l}_{k , q , {D}_{k}}} ]}^{T} ∈ {ℝ}^{{D}_{k}} , {l}_{k , q} = 1 , ⋯ , {N}_{k , q} ;$$

and an index relationship satisfies:

$${l}_{k , q} = map ( ( {l}_{k , q , 1} , ⋯ , {l}_{k , q , {D}_{k}} ) ) , ( {l}_{k , q , 1} , ⋯ , {l}_{k , q , {D}_{k}} ) = map ( {l}_{k , q} ) ;$$

$$where :$$

$${l}_{k , q} = ( {l}_{k , q , 1} - 1 ) \times {N}_{k , q , {i}_{1} + 1} \times ⋯ \times {N}_{k , q , {D}_{k}} + ( {l}_{k , q , 2} - 1 ) \times {N}_{k , q , {i}_{1} + 2} ⋯ \times {N}_{k , q , {D}_{k}} + ⋯ + {l}_{k , q , {D}_{k}} ;$$

and a range of each direction index is defined as:

$${l}_{k , q , {i}_{k}} = 1 , ⋯ , {N}_{k , q , {i}_{k}} , {i}_{k} = 1 , ⋯ , {D}_{k} ;$$

and a total number of candidates is:

$${N}_{k , q} = L ( \{ {\tilde{ϑ}}_{k , q} \} ) = {N}_{k , q , 1} \times ⋯ \times {N}_{k , q , {D}_{k}} {\{ {\tilde{ϑ}}_{k , q , {i}_{k}} \}}_{{l}_{k , q , {i}_{k}}} ∈ {ℝ}^{1} .$$

Example 8: In a three-dimensional space, when a peak location (α, β, γ) of beamforming output power is respectively at ϑ_{1,1,1}=β=35.8071°, ϑ_{1,1,2}=α=17.5154°, and ϑ_{2,1,1}=γ=−131.0488°, the joint/full three-dimensional (3D) search space [symbol] _{F} can be decomposed into:
(1) a first search space [symbol] _{D,1}∈ [symbol] ^{D}^{₁}⁼², which is spanned by e₂(β) and e₃(α), where i₁=1,2; and
(2) a second search space [symbol] _{D,2}∈ [symbol] ^{D}^{₂}⁼¹, which is spanned by e₁(γ), where i₂=1.

For the first stage of the first search space [symbol] _{D,1}, an estimate [symbol] _{1,1}∈ [symbol] ¹ obtained from other search spaces must be provided; wherein [symbol] _{1,1} lies in a space other than the first search space [symbol] _{D,1}, specifically: [symbol] _{1,1}=GivenEstimate=RG(γ)= [symbol] _{1,1,1}=45°, where RG(γ) represents a random guess of γ.

For the first stage of the first space [symbol] _{D,1}, the search candidate set V_{1,1}={\tilde{ϑ}_{1,1,1}}∈ [symbol] ² is defined as follows:

$${Θ}_{1 , 1 , 1} = 90 ° , {Δϑ}_{1 , 1 , 1} = 6 ° , {l}_{1 , 1 , 1} ( 1 ) = 4 ° .$$

$${Θ}_{1 , 1 , 2} = 360 ° , {Δϑ}_{1 , 1 , 2} = 6 ° , {l}_{1 , 1 , 2} ( 1 ) = 4 ° .$$

$${V}_{1 , 1 , 1} = \{ {\tilde{ϑ}}_{1 , 1 , 1} \} = \{ 3 ° : 6 ° : 87 ° \} , {N}_{1 , 1 , 1} = 15.$$

$${V}_{1 , 1 , 2} = \{ {\tilde{ϑ}}_{1 , 1 , 2} \} = \{ - 177 ° : 6 ° : 177 ° \} , {N}_{1 , 1 , 2} = 60 .$$

In the first stage of the first search space [symbol] _{D,1}, a peak location detection (PLD) result \hat{ϑ}_{1,1} ∈ [symbol] ² is expressed as:

$$[ {\hat{ϑ}}_{1 , 1} , {P}_{1 , 1 , {\hat{l}}_{1 , 1}} ] = PLD ( {\hat{\overline{ϑ}}}_{1 , 1} , \{ {\tilde{ϑ}}_{1 , 1} \} ) ,$$

$$where :$$

$${\hat{ϑ}}_{1 , 1} = {[ {\hat{ϑ}}_{1 , 1 , 1} , {\hat{ϑ}}_{1 , 1 , 2} ]}^{T} = {[ 33 ° , 15 ° ]}^{T} ,$$

and a corresponding output power is:

$${P}_{1 , 1 , {\hat{l}}_{1 , 1}} = 8.4 \; 886 [ dB ] .$$

For a second stage of the first search space [symbol] _{D,1}, an estimate [symbol] _{1,2} ∈ [symbol] ¹ obtained from other search spaces must be provided, wherein [symbol] _{1,2} is not located in the first search space [symbol] _{D,1}, specifically: [symbol] _{1,2}=GivenEstimate=RG(γ)= [symbol] _{1,2,1}=45°.

For the second stage of the first search space [symbol] _{D,1}, the search candidate set V_{1,2}={\tilde{ϑ}_{1,2}}∈ [symbol] ² is defined as follows:

$${Θ}_{1 , 2 , 1} = 2 {Δϑ}_{1 , 1 , 1} = 12 ° , {Δϑ}_{1 , 2 , 1} = 3 ° , {l}_{1 , 2 , 1} ( 1 ) = 1 ° .$$

$${Θ}_{1 , 2 , 2} = 2 {Δϑ}_{1 , 1 , 2} = 12 ° , {Δϑ}_{1 , 2 , 2} = 3 ° , {l}_{1 , 2 , 2} ( 1 ) = 1 ° .$$

$${V}_{1 , 2 , 1} = \{ {\tilde{ϑ}}_{1 , 2 , 1} \} = \{ 27 ° : 3 ° : 39 ° \} , {N}_{1 , 2 , 1} = 5.$$

$${V}_{1 , 2 , 2} = \{ {\tilde{ϑ}}_{1 , 2 , 2} \} = \{ 9 ° : 3 ° : 21 ° \} , {N}_{1 , 2 , 2} = 5 .$$

For the second stage of the first search space [symbol] _{D,1}, a peak location detection (PLD) result \hat{ϑ}_{1,2}∈ [symbol] ² is expressed as follows:

$$[ {\hat{ϑ}}_{1 , 2} , {P}_{1 , 2 , {\hat{l}}_{1 , 2}} ] = PLD ( {\hat{\overline{ϑ}}}_{1 , 2} , \{ {\tilde{ϑ}}_{1 , 2} \} ) ,$$

$$where :$$

$${\hat{ϑ}}_{1 , 2} = {[ {\hat{ϑ}}_{1 , 2 , 1} , {\hat{ϑ}}_{1 , 2 , 2} ]}^{T} = {[ 36 ° , 18 ° ]}^{T} ,$$

and a corresponding output power is:

$${P}_{1 , 2 , {\hat{l}}_{1 , 2}} = 26.0 \; 620 [ dB ] .$$

For a first stage of the second search space [symbol] _{D,2}, an estimate [symbol] _{2,1} ∈ [symbol] ² obtained from other search spaces must be provided, wherein [symbol] _{2,1} is taken from an output result of peak location detection in the second stage of the first search space [symbol] _{D,1}, specifically: [symbol] _{2,1}=GivenEstimate= [symbol] _{1,2}=[ [symbol] _{1,2,1}, [symbol] _{1,2,2}]^{T}=[36°, 18° ]^{T}.

For the first stage of the second search space [symbol] _{D,2}, the search candidate set V_{2,1}={\tilde{ϑ}_{2,1}}∈ [symbol] ¹ is defined as follows:

$${Θ}_{2 , 1 , 1} = 180 ° , {Δϑ}_{2 , 1 , 1} = 6 ° , {l}_{2 , 1 , 1} ( 1 ) = 4 ° ;$$

and the candidate points thereof are:

$${V}_{2 , 1 , 1} = \{ {\tilde{ϑ}}_{2 , 1 , 1} \} = \{ - 177 ° : 6 ° : - 3 ° \} , {N}_{2 , 1 , 1} = 30 .$$

For the first stage of the second search space [symbol] _{D,2}, a peak location detection (PLD) result \hat{ϑ}_{2,1} ∈ [symbol] ¹ is expressed as follows:

$$[ {\hat{ϑ}}_{2 , 1} , {P}_{2 , 1 , {\hat{l}}_{2 , 1}} ] = PLD ( {{ϑ}^{\hat{\_}}}_{2 , 1} , \{ {\tilde{ϑ}}_{2 , 1} \} ) ,$$

$$\text{where:}$$

$${\hat{ϑ}}_{2 , 1} = {\hat{ϑ}}_{2 , 1 , 1} = - 129 ° ,$$

and a corresponding output power is:

$${P}_{2 , 1 , {\hat{l}}_{2 , 1}} = 29.7 \; 611 [ dB ] .$$

For a second stage of the second search space [symbol] _{D,2}, an estimate [symbol] _{2,2} ∈ [symbol] ² obtained from other search spaces must be provided, wherein [symbol] _{2,2} is taken from an output result of peak location detection in the second stage of the first search space [symbol] _{D,1}, specifically: [symbol] _{2,2}=GivenEstimate=\hat{ϑ}_{1,2}=[\hat{ϑ}_{1,2,1}, \hat{ϑ}_{1,2,2}]^{T}=[36°, 18°]^{T}.

For the second stage of the second search space [symbol] _{D,2}, the search candidate set V_{2,2}={\tilde{ϑ}_{2,2}}∈ [symbol] ¹ is defined as follows:

$${Θ}_{2 , 2 , 1} = 2 {Δϑ}_{2 , 1 , 1} = 12 ° , {Δϑ}_{2 , 2 , 1} = 3 ° , {l}_{2 , 2 , 1} ( 1 ) = 1 ° ;$$

and the candidate points thereof are:

$${V}_{2 , 2 , 1} = \{ {\tilde{ϑ}}_{2 , 2 , 1} \} = \{ - 135 ° : 3 ° : - 123 ° \} , {N}_{2 , 2 , 1} = 5 .$$

For the second stage of the second search space [symbol] _{D,2}, a peak location detection (PLD) result \hat{ϑ}_{2,2} ∈ [symbol] ¹ is expressed as follows:

$$[ {\hat{ϑ}}_{2 , 2} , {P}_{2 , 2 , {\hat{l}}_{2 , 2}} ] = PLD ( {{ϑ}^{\hat{\_}}}_{2 , 2} , \{ {\tilde{ϑ}}_{2 , 2} \} ) ,$$

$$\text{where:}$$

$${\hat{ϑ}}_{2 , 2} = {\hat{ϑ}}_{2 , 2 , 1} = - 132 ° ,$$

and a corresponding output power is:

$${P}_{2 , 2 , {\hat{l}}_{2 , 2}} = 29.7 \; 633 [ dB ] .$$

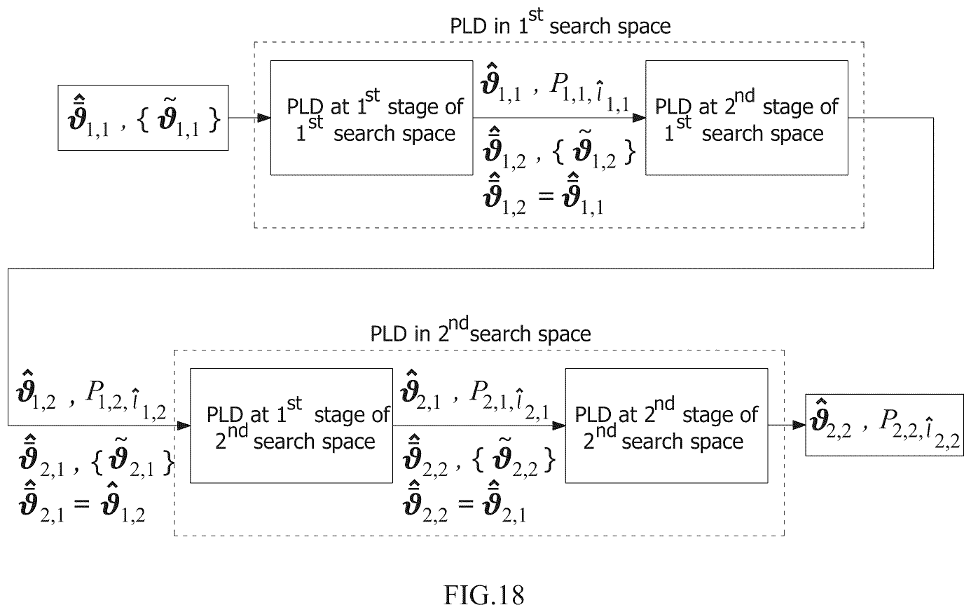

FIGS. 17 and 18 show an overall detailed detection process of this example.

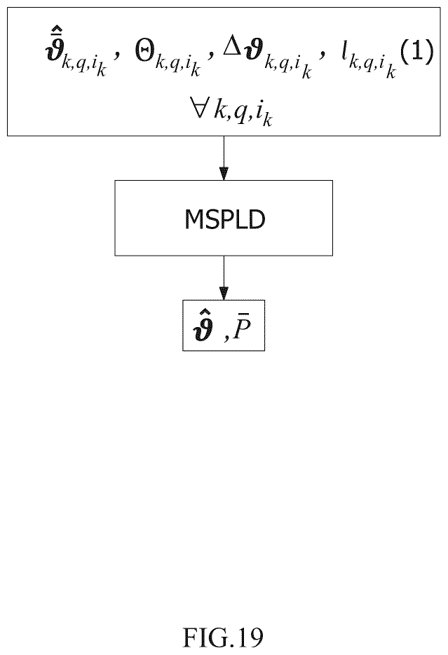

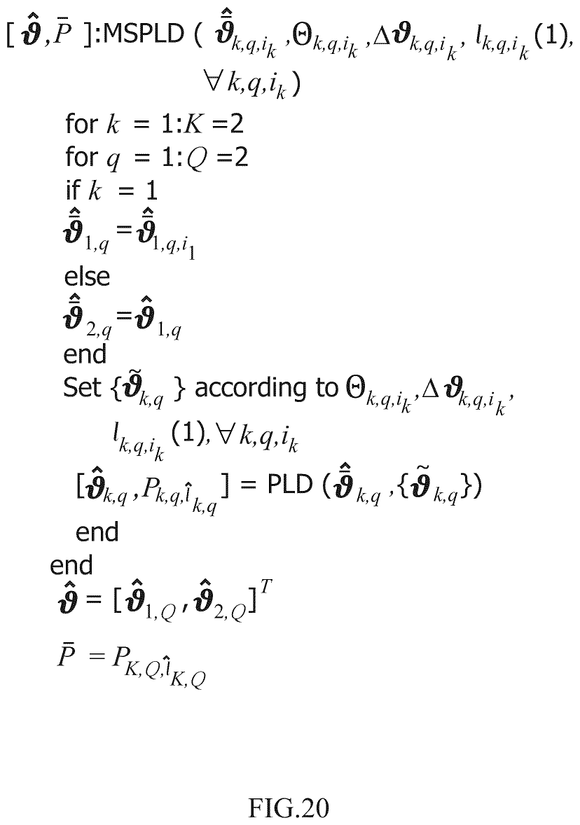

FIGS. 19 and 20 show a multi-stage peak location detection (MSPLD) algorithm applicable to all separate search spaces.

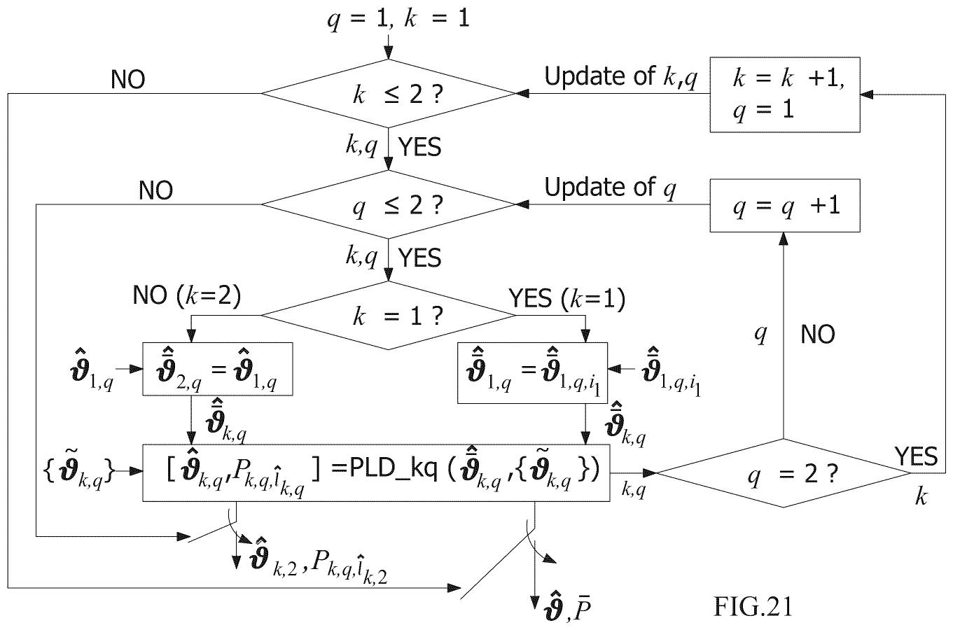

FIG. 21 shows a flowchart of the multi-stage peak location detection (MSPLD) process for all separate search spaces according to the present invention.

### APPENDIX: ARRAY INDEX MAPPING

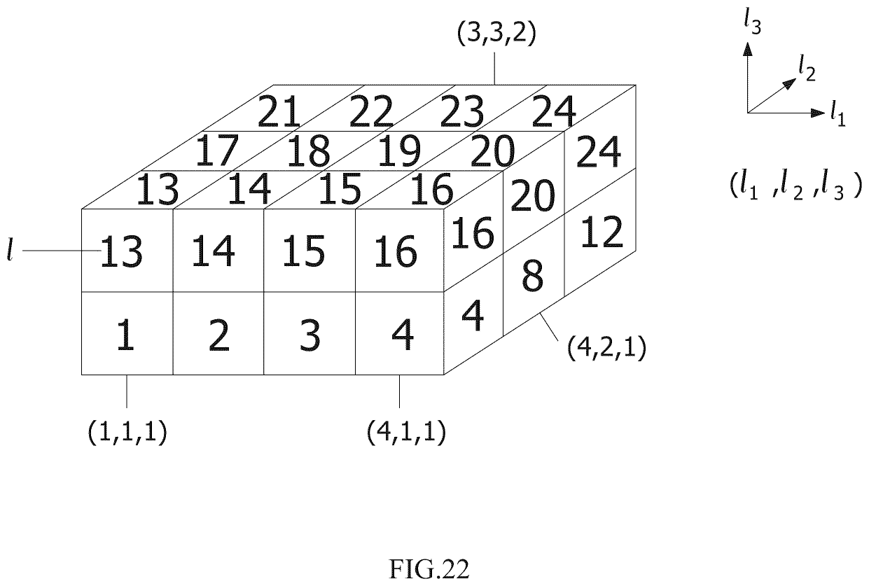

Array index mapping, as shown in FIG. 22, represents a conversion (mapping) between one-dimensional (1D) and three-dimensional (3D) indices. This mapping is defined by the following relationships.

$$Defining {\{ \tilde{ϑ} \}}_{l} ≡ {[ {\{ {\tilde{ϑ}}_{1} \}}_{{l}_{1}} , {\{ {\tilde{ϑ}}_{2} \}}_{{l}_{2}} , {\{ {\tilde{ϑ}}_{3} \}}_{{l}_{3}} ]}^{T} ∈ {ℝ}^{3} , \\ l = 1 , … , {N}_{F} , {l}_{i} = 1 , … {N}_{i} , \\ i = 1 , 2 , 3 ,$$

a relationship from three-dimensional (3D) indices to a one-dimensional (1D) index can be established as:

$$l = map ( ( {l}_{1} , {l}_{2} , {l}_{3} ) ) ,$$

representing a mapping from three-dimensional (3D) indices (l₁, l₂, l₃) to a one-dimensional (1D) index l; and conversely,

$$( {l}_{1} , {l}_{2} , {l}_{3} ) = map ( l ) ,$$

representing a mapping from a one-dimensional (1D) index l to three-dimensional (3D) indices (l₁, l₂, l₃).

### Example 1: Conversion from Three-Dimensional (3D) Indices to a One-Dimensional (1D) Index

Given three-dimensional coordinates (x, y, z)=(2,3,2), and lengths in the x, y, and z directions respectively defined as Mₓ, M_{y}, and M_{z}, a corresponding one-dimensional (1D) index i is:

$$i = x + {M}_{x} ( ( y - 1 ) + {M}_{y} ( z - 1 ) ) = 2 + 3 ( ( 3 - 1 ) + 3 ( 2 - 1 ) ) = 17 .$$

### Example 2: Conversion from a One-Dimensional (1D) Index to Three-Dimensional (3D) Indices

Given a one-dimensional index i=17, and lengths in the x, y, and z directions respectively (Mₓ, M_{y}, M_{z})=(3,3,2), the corresponding three-dimensional (3D) indices (x, y, z) are:

$$z = ⌈ \frac{i}{{M}_{x} {M}_{y}} ⌉ = ⌈ \frac{17}{9} ⌉ = 2 , \\ y = ⌈ \frac{i - ( z - 1 ) {M}_{x} {M}_{y}}{{M}_{x}} ⌉ = ⌈ \frac{17 - ( 2 - 1 ) 9}{3} ⌉ = 3 , \\ x = i - {M}_{x} ( ( y - 1 ) + {M}_{y} ( z - 1 ) ) = 17 - 3 ( ( 3 - 1 ) + 3 ( 2 - 1 ) ) = 2 .$$

### Example 3: Conversion from Two-Dimensional (2D) Indices to a One-Dimensional (1D) Index

Given (x, y)=(2,3), (Mₓ, M_{y})=(3,3), and z=M_{z}=1, a corresponding one-dimensional (1D) index i is:

$$i = x + {N}_{x} ( ( y - 1 ) + {N}_{y} ( z - 1 ) ) = 2 + 3 ( ( 3 - 1 ) + 3 ( 1 - 1 ) ) = 8 .$$

### Example 4: Conversion from a One-Dimensional (1D) Index to Two-Dimensional (2D) Indices

Given i=8, (Mₓ, M_{y})=(3,3), and z=M_{z}=1, a corresponding two-dimensional index (x, y) is:

$$y = ⌈ \frac{i}{{M}_{x}} ⌉ = ⌈ \frac{8}{3} ⌉ = 3 , \\ x = i - {M}_{x} ( ( y - 1 ) ) = 8 - 3 ( ( 3 - 1 ) ) = 2 .$$

By decomposing the joint/full three-dimensional (3D) search space [symbol] _{F} into a plurality of lower-dimensional separate search spaces, in conjunction with a multi-stage peak location detection strategy employing progressively decreasing step sizes and combined with an angular hopping procedure, the overall number of searches is effectively reduced, computational complexity is decreased, and decision time is shortened. Compared to the prior art, which requires searching the joint/full three-dimensional (3D) search space [symbol] _{F} through a direct brute-force mechanism, the present invention significantly reduces computational resource consumption and antenna operation times, avoids problems of local extrema or power dead zones, and improve real-time performance and system stability. Furthermore, by effectively controlling the number and amplitude of search operations, mechanical wear on the antenna is reduced, equipment lifespan is extended, and satellite communication link beam alignment can be performed both quickly and accurately, thereby enhancing overall communication performance.

What is claimed is:

1. A multi-stage peak location detection method for satellite communications, comprising:
decomposing a joint/full three-dimensional (3D) search space into a plurality of lower-dimensional separate search spaces;
performing peak location detection in each of the separate search spaces through a multi-stage process employing progressively decreasing step sizes; and
executing angular hopping during the peak location detection to avoid effects of power dead zones;
wherein the method achieves beam alignment with a target satellite while reducing a total number of searches.

2. The method according to claim 1, wherein the joint/full three-dimensional (3D) search space is decomposed into at least one two-dimensional (2D) search space and one one-dimensional (1D) search space through spatial decoupling.

3. The method according to claim 1, wherein the multi-stage peak location detection comprises a first stage and a second stage, the first stage performing searching with a larger step size over a larger range, and the second stage performing searching with a smaller step size over a smaller range.

4. The method according to claim 3, wherein a search range of the second stage is twice a step size of the first stage.

5. The method according to claim 3, wherein the step size is smaller than a 3 dB beamwidth of a corresponding search direction, thereby avoiding effects of local minima or maxima.

6. The method according to claim 4, wherein the step size is smaller than a 3 dB beamwidth of a corresponding search direction, thereby avoiding effects of local minima or maxima.

7. The method according to claim 1, wherein the angular hopping introduces random displacements between search candidate points to avoid detection failure caused by power dead zones.

8. The method according to claim 1, wherein curve fitting techniques are further employed in a final search space to improve accuracy of peak location detection.

9. The method according to claim 1, wherein each stage of the multi-stage peak location detection includes a peak location detection module comprising a predetermined input estimate value, a search range, a starting point, and a step size.

10. The method according to claim 9, wherein the predetermined input estimate value is a random guess or an estimated value obtained from other search spaces.

11. The method according to claim 1, wherein the joint/full three-dimensional (3D) search space is spanned by three orthogonal basis vectors.
